(19) United States
(12) Patent Application Publication
(10) Pub. No.: US 2021/0191029 A1
(43) Pub. Date: Jun. 24, 2021

(54) BACKLIGHT MODULE AND DISPLAY DEVICE

(71) Applicant: BOE TECHNOLOGY GROUP CO., LTD., Beijing (CN)

(72) Inventors: Liangliang JIN, Beijing (CN); Zezhou YANG, Beijing (CN); Ruoyu MA, Beijing (CN)

(21) Appl. No.: 16/997,214

(22) Filed: Aug. 19, 2020

(30) Foreign Application Priority Data
Dec. 18, 2019 (CN) 201911308989.1

(51) Int. Cl. F21V 8/00; G02B 27/01

(52) U.S. Cl. CPC G02B 6/0053; G02B 27/0172; G02B 6/0068; G02B 6/0055

(57) ABSTRACT

A backlight module includes: a light guide plate, and a prism film located on a side of a light exit surface of the light guide plate including a substrate and a plurality of strip-shaped prisms disposed on a side of the substrate facing the light guide plate, extending in a first direction and arranged in a second direction; and the base angles of each strip-shaped satisfy conditions that two light rays exiting from the light guide plate that have symmetrical angles with a normal line of the light exit surface of the light guide plate are respectively incident on two sides of the strip-shaped prism, and then exit in a same set light exit direction the prism film has at least two light exit directions. The two light rays are respectively emitted by the side-type backlight and reflected by the reflective sheet, or are respectively emitted by the double light bars.

### CROSS REFERENCE

This disclosure is based upon and claims priority to Chinese Patent Disclosure No. 201911308989.1, filed on Dec. 18, 2019, the entire contents thereof are incorporated herein by reference.

### TECHNICAL FIELD

The present disclosure relates to the field of display technology, and particularly to a backlight module and a display device.

### BACKGROUND

In related arts, a size of a Virtual Reality (VR) display product is relatively small, and with continuous development of VR system, the size of a VR display product continues to decrease. For example, the sizes of some VR display products have been reduced to 2.48 inches. A VR display product includes a backlight module and a Liquid Crystal Display (LCD) module. In order to meet the demand for high brightness of the VR display product, the backlight module is generally provided with a side-type backlight and a reflective sheet on two opposite sides of the light guide plate, or, provided with a side-type backlight composed of double light bars. However, as the size of the VR display product decreases, the distance between the side-type backlight and the reflective sheet is shortened. More and more lights emitted by the side-type backlight will be reflected by the reflective sheet and become reflected lights, and the reflected lights have relatively long optical paths. In addition, after the side-type backlight composed of double light bars is guided by the light guide plate, it will become uniform emitting light after the diffuser above the light guide plate and the prism group act together on it.

### SUMMARY

Accordingly, embodiments of the present disclosure provide a backlight module and a display device.

Embodiments of the present disclosure provide a backlight module, including: a light guide plate, and a prism film located on a side of a light exit surface of the light guide plate;

the prism film includes: a substrate, and a plurality of strip-shaped prisms disposed on a side of the substrate facing the light guide plate, the plurality of strip-shaped prisms extending in a first direction and arranged in a second direction;

each of the strip-shaped prisms includes a first base angle and a second base angle, and the first base angle and the second base angle satisfy following conditions that after two light rays exiting from the light guide plate that have symmetrical angles with a normal line of the light exit surface of the light guide plate are respectively incident on two sides of the each of the strip-shaped prisms corresponding to the first base angle and the second base angle, the two light rays exit in a same set light exit direction; the prism film has at least two light exit directions.

### BRIEF DESCRIPTION OF THE DRAWINGS

FIG. 1A, FIG. 1B, FIG. 2A, and FIG. 2B are schematic structural diagrams of a backlight module according to embodiments of the present disclosure;

FIG. 3 is a schematic structural diagram of a prism film according to embodiments of the present disclosure

FIG. 4 is an enlarged schematic diagram of optical paths through a single strip-shaped prism in FIG. 1A, FIG. 1B, FIG. 2A and FIG. 2B;

FIG. 5 and FIG. 6 are schematic diagrams of a propagation path of light ray through a prism film;

FIG. 7 is a plane of g(α₁, α₂) when C is assigned different values and a curved surface of f(α₁, α₂) ;

FIG. 8 shows the numerical curve of f(α₁, α₂) corresponding to different values of α₃;

FIG. 9 is a schematic diagram of a simulated optical path of light exiting in given direction in a light exit region of a prism film;

FIG. 10 shows light pattern of angular brightness distribution of a light guide plate in the related arts;

FIG. 11 to FIG. 13 respectively show light patterns of angular brightness distribution of the light exiting from a light guide plate in the related arts at three positions on a prism film provided in the embodiments of the present disclosure.

### DETAILED DESCRIPTION

In order to make the purpose, technical solutions and advantages of the embodiments of the present disclosure clearer, technical solutions of the embodiments of the present disclosure will be described clearly and completely in conjunction with the accompanying drawings of the embodiments of the present disclosure. Obviously, the embodiments described are part of the embodiments of the present disclosure, rather than all the embodiments. Based on the described embodiments of the present disclosure, all other embodiments obtained by ordinary skilled in the art without creative labor are within the protection scope of the disclosure.

Unless otherwise defined, technical terms or scientific terms used herein shall be ordinary meanings understood by those with skilled in the art to which the disclosure belongs. The “first”, “second” and similar words used in the specification and claims of the disclosure do not indicate any order, quantity or importance, but are only used to distinguish different components. “Include” or “comprise” and other similar words mean that the element or item appearing before the word covers the element or item listed after the word and their equivalents, but does not exclude other elements or items. “Inner”, “Outer”, “upper”, “lower”, etc. are only used to indicate the relative position relationship, when the absolute position of the described object changes, the relative position relationship may also change accordingly.

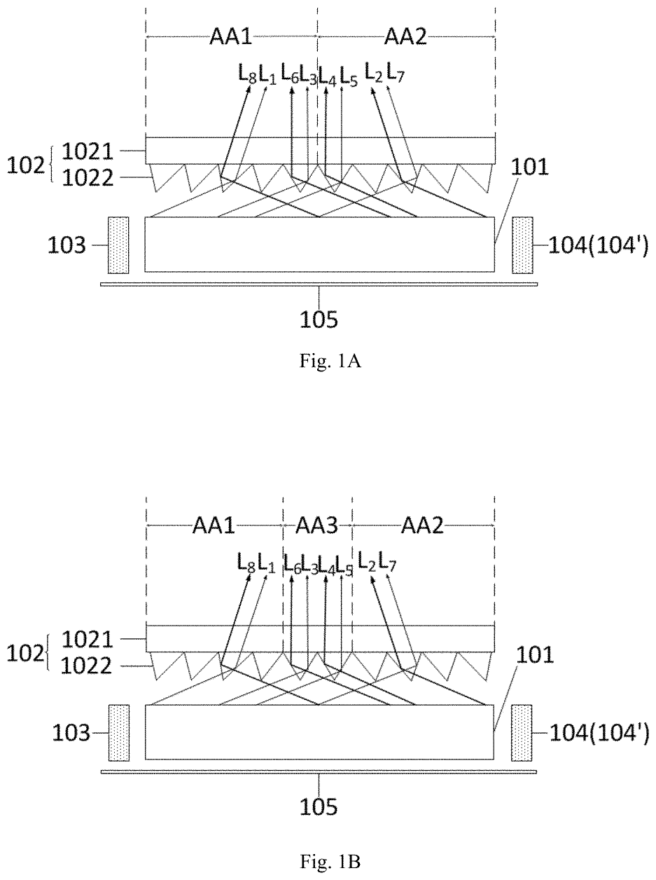

Embodiments of the present disclosure provides a backlight module, as shown in FIG. 1A and FIG. 2A, including: a light guide plate 101, and a prism film 102 located on a side of a light exit surface of the light guide plate 101; where

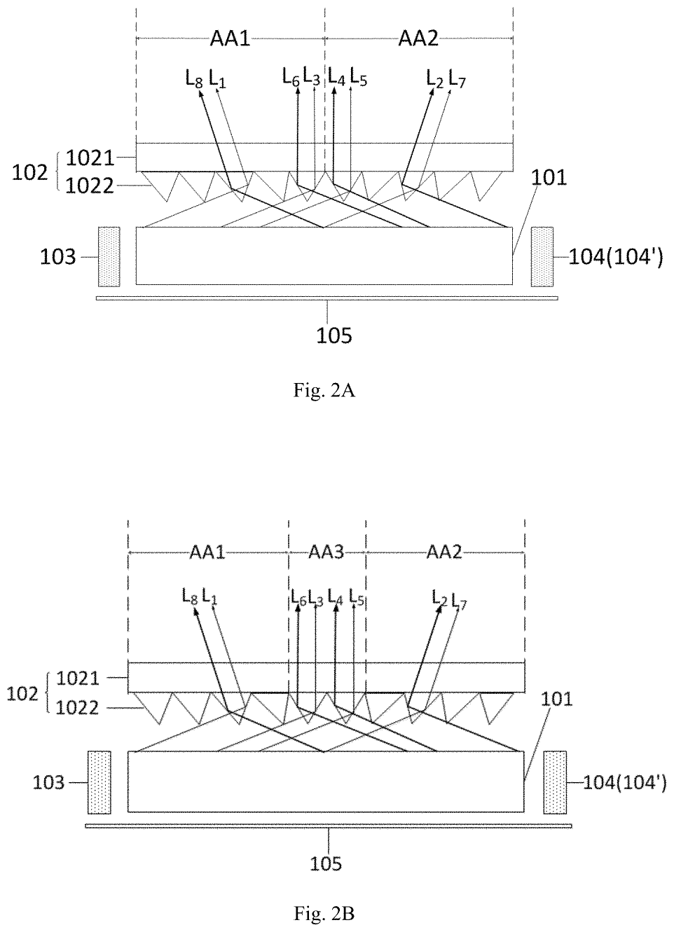

the prism film 102 includes a substrate 1021, and a plurality of strip-shaped prisms 1022 disposed on a side of the substrate 1021 facing the light guide plate 101, extending in a first direction Y and arranged in a second direction X, as shown in FIG. 3;

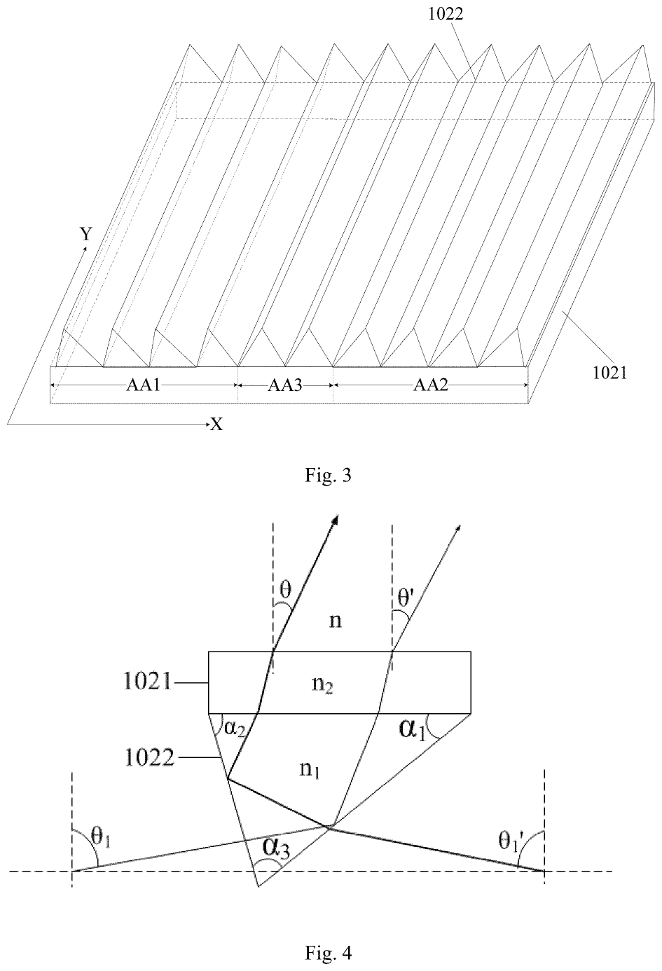

each of the strip-shaped prisms 1022 includes a first base angle α₁ and a second base angle α₂, and the first base angle α₁ and the second base angle α₂ satisfy the following conditions that after two light rays exiting from the light guide plate 101 that have symmetrical angles θ₁ and θ₁′ with a normal line of the light exit surface of the light guide plate are respectively incident on two sides of the strip-shaped prism 1022 corresponding to the first base angle α₁ and the second base angle α₂, and then exit in a same set light exit direction (that is, the angle θ and θ′ are equal or the difference between them is within an error range which does not affect use), as shown in FIG. 4; the prism film 102 has at least two light exit directions, and specifically, three light exit directions are exemplarily shown in FIG. 1A and FIG. 2A.

In the backlight module provided by the embodiments of the present disclosure, the main cross-section of each of the strip-shaped prisms 1022 is a plane passing through the second direction X and perpendicular to the first direction Y. The side close to the substrate 1021 in the main cross-section of each of the strip-shaped prisms 1022 is the base, the angle away from the substrate 1021 in the main cross-section of each of the strip-shaped prisms 1022 is the vertex angle, and the angle in the main cross-section of each of the strip-shaped prisms 1022 close to the substrate 1021 is the base angle.

In the backlight module provided by the embodiments of the present disclosure, the first base angle α₁ and the second base angle α₂ of the strip-shaped prism 1022 satisfy the following conditions that after two light rays exiting from the light guide plate 101 that have symmetrical angles with the normal line are respectively incident on two sides of the strip-shaped prism 1022, and then exit in a same set light exit direction; the prism film 102 has at least two light exit directions. Specifically, the two light rays exiting from the light guide plate 101 that have symmetrical angles with the normal line are respectively the light rays emitted by the side-type backlight 103 exiting from the light guide plate 101 (for example, light rays L₁, L₃, L₅ and L₇ incident from the left side in FIG. 1A and FIG. 2A) and the light rays reflected by the reflective sheet 104 (for example, light rays L₂, L₄, L₆ and L₈ incident from the right side in FIG. 1A and FIG. 2A), or, are respectively the light rays emitted by the double light bars exiting from the light guide plate 101 (for example, light rays L₁, L₃, L₅ and L₇ incident from the left side and light rays L₂, L₄, L₆ and L₈ incident from the right side in FIG. 1A and FIG. 2A, respectively). Therefore, in the present disclosure, the prism film 102 achieves light exit in given direction on the incident lights in two directions, which improves light energy utilization.

It should be noted that the prism film 102 do not need to be fixed to the light guide plate 101 via optical glue or other components. In a specific implementation, the prism film 102 may be in direct contact with the light exit surface of the light guide plate 101, and between the prism film 102 and the light guide plate 101, there is only an air medium filling the gap between the light guide plate 101 and each of the strip-shaped prisms 1022. In FIG. 1A and FIG. 2A, for convenience of description, the prism film 102 is not in contact with the light exit surface of the light guide plate 101.

Optionally, in the backlight module provided by the embodiments of the present disclosure, the prism film 102 is divided into at least two light exit regions extending in the first direction Y and arranged in the second direction X, light exit directions of each of the strip-shaped prisms 1022 in one light exit region are the same, and light exit directions of each of the strip-shaped prisms 1022 in different light exit regions are different.

In actual application, it is generally necessary that lights exit in a plurality of designated directions. Therefore, in the backlight module provided by the embodiments of the present disclosure, the prism film 102 includes at least a pair of a first light exit region AA1 and a second light exit region AA2 that are symmetrically distributed around a central axis extending in the first direction Y, and the light exit direction of the first light exit region AA1 and the light exit direction of the second light exit region AA2 are opposite and have the same angle with the normal line.

In FIG. 1A and FIG. 2A, five pairs of first light exit region AA1 and second light exit region AA2 that are symmetrically distributed around the central axis extending in the first direction Y are exemplarily shown. Specifically, the region where the N-th strip-shaped prism 1022 from the left side and the region where the N-th strip-shaped prism 1022 from the right side form a pair of first light exit region AA1 and second light exit region AA2, and light exit directions of each pair of the first light exit region AA1 and the second light exit region AA2 are opposite and have the same angle with the normal line, where N is a positive integer less than or equal to 5. Of course, in a specific implementation, it may be that one strip-shaped prism is arranged in each light exit region as shown in FIG. 1A and FIG. 2A, and it may also be that a plurality of identical strip-shaped prisms are arranged in each light exit region, which is not limited here.

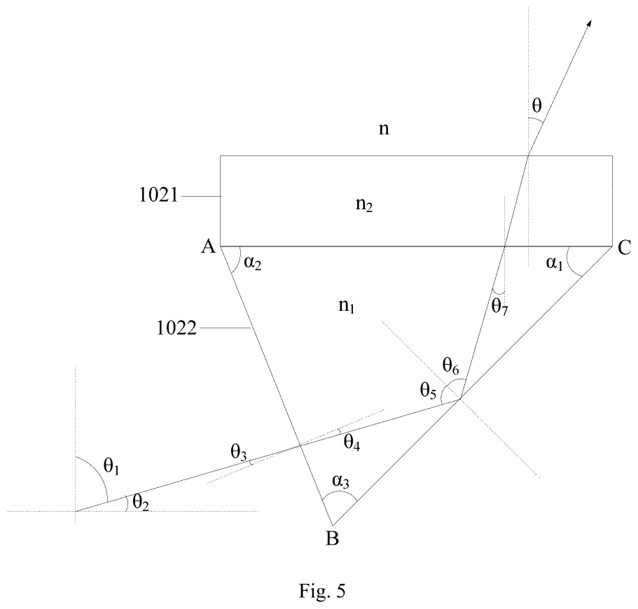

Optionally, in the backlight module provided by the embodiments of the present disclosure, light directivity may be achieved by adjusting the base angles of the strip-shaped prism 1022. Specifically, in a pair of the first light exit region AA1 and the second light exit region AA2, the first base angle α₁ of each of the strip-shaped prisms 1022 may be set to be smaller than the second base angle α₂, and the first base angle α₁ and the light exit direction of the strip-shaped prism 1022 are on the same side of the normal line, as shown in FIG. 5 and FIG. 6.

Optionally, in the backlight module provided by the embodiments of the present disclosure, the greater a difference between the first base angle α₁ and the second base angle α₂ is, the greater an angle at which the light exit direction of the strip-shaped prism 1022 deviates from the normal line is. For example, in FIG. 1A, in the direction from the first strip-shaped prism 1022 on the left side to the fourth strip-shaped prism 1022 on the left side, the difference between the first base angle α₁ and the second base angle α₂ gradually becomes smaller, and the angle at which the light exit direction of the strip-shaped prism 1022 deviates from the normal line is gradually reduced; and in the direction from the first strip-shaped prism 1022 on the right side to the fourth strip-shaped prism 1022 on the right side, the difference between the first base angle α₁ and the second base angle α₂ gradually becomes smaller, and the angle at which the light exit direction of the strip-shaped prism 1022 deviates from the normal line is gradually reduced, which makes that light rays exiting from the prism film 102 point to the central axis, that is, converges toward the middle area. For another example, in FIG. 2A, in the direction from the fourth strip-shaped prism 1022 on the left side to the first strip-shaped prism 1022 on the left side, the difference between the first base angle α₁ and the second base angle α₂ gradually becomes larger, and the angle at which the light exit direction of the strip-shaped prism 1022 deviates from the normal line is gradually increased; and in the direction from the fourth strip-shaped prism 1022 on the right side to the first strip-shaped prism 1022 on the right side, the difference between the first base angle α₁ and the second base angle α₂ gradually becomes larger, and the angle at which the light exit direction of the strip-shaped prism 1022 deviates from the normal line is gradually increased, which makes that light rays exiting from the prism film 102 deviate from the central axis, that is, diverge to both sides.

Optionally, in the backlight module provided in the embodiments of the present disclosure, as shown in FIG. 1B and FIG. 2B, the prism film 102 may further include a third light exit region AA3 located between the first light exit region AA1 and the second light exit region AA2;

a light exit direction of the third light exit region AA3 is parallel to the normal line.

Optionally, in the backlight module provided in the embodiments of the present disclosure, two base angles of each of the strip-shaped prisms 1022 in the third light exit region AA3 are the same. By arranging two same base angles, the light exit direction of the third light emitting area AA3 is parallel to the normal line.

Optionally, in the backlight module provided in the embodiments of the present disclosure, as shown in FIG. 1A and FIG. 2A, each of the strip-shaped prisms 1022 is a strip-shaped triangular prism, and in the main cross-section of each of the strip-shaped prisms 1022, vertex angles on a side away from the substrate are the same. Generally, there is a cutting tool angle corresponding to the processing of each of the strip-shaped prisms, and by setting the same vertex angles of the strip-shaped prisms, the same cutting tool may be used in the process of processing each of the strip-shaped prisms, which may avoid replacement of the cutting tools and improve productivity.

It can be understood that the same vertex angles in the main cross-section of each of the strip-shaped prisms on the side away from the substrate 1021 is a preferred embodiment. In specific implementations, the vertex angles in the main cross-section of each of the strip-shaped prisms away from the substrate 1021 may also be different, which is not limited here.

Optionally, in the backlight module provided in the embodiments of the present disclosure, in the main cross-section of each of the strip-shaped prisms, bases on a side close to the substrate 1021 are equal. In the case that the vertex angle and the base are constant, the height of each of the strip-shaped prisms may be determined according to the base angle matched with the preset light exit direction of different light exit region, which is convenient to realize the processing of each of the strip-shaped prisms.

Optionally, in the backlight module provided in the embodiments of the present disclosure, heights of a main cross-section of each of the strip-shaped prisms are equal. In the case that the vertex angle and the height are constant, the length of the base of each of the strip-shaped prisms may be determined according to the base angle matched with the preset light exit directions of different light exit regions, which is convenient to realize the processing of each of the strip-shaped prisms.

It can be understood that the same bases in the main cross-section of each of the strip-shaped prisms on the side close to the substrate 1021 is a preferred embodiment. In specific implementations, the bases in the main cross-section of each of the strip-shaped prisms close to the substrate 1021 may also be different, which is not limited here.

Generally, in the backlight module provided in the embodiments of the present disclosure, as shown in FIG. 1A and FIG. 2A, it may further include: a first light source 103 located on a first side of the light guide plate 101, a second light source 104 or a reflective sheet 104′ located on a second side of the light guide plate 101, and a back plate 105 located on an opposite side of the light exit surface of the light guide plate 101 where the first side is arranged opposite to the second side.

In order to better understand technical solutions of the backlight modules provided by the present disclosure, the backlight module shown in FIG. 1A will be described in detail below.

As to the backlight module shown in FIG. 1A, the light rays L₁, L₃, L₅ and L₇ emitted from the first light source 103 (such as a LED light bar) pass through the light guide plate 101 and the prism film 102 and then respectively exit in four set directions in four positions; the light rays L₂, L₄, L₆ and L₈ emitted from the second light source 104 (such as a LED light bar) or reflected by the reflective sheet 104′ pass through the light guide plate 101 and the prism film 102 and then exit in four set directions in four positions respectively. Among them the light ray L₁ and the light ray L₈ have symmetrical angles with the normal line after exiting from the light guide plate 101, the light ray L₃ and the light ray L₆ have symmetrical angles with the normal line after exiting from the light guide plate 101, the light ray L₅ and the light ray L₄ have symmetrical angles with the normal line after exiting from the light guide plate 101, and the light ray L₇ and the light ray L₂ have symmetrical angles with the normal line after exiting from the light guide plate 101. The prism film 102 is bilaterally symmetrical around the central axis extending in the first direction Y. By adjusting the angle of the strip-shaped prism 1022, the exit directions of the light ray L₁ and the light ray L₈ exiting from the same strip-shaped prism 1022 (for example, the angle between the exit direction and the normal line is 20°) may be the same, the exit directions of the light ray L₃ and the light ray L₆ exiting from the same strip-shaped prism 1022 may be the same (for example, parallel to the normal line), the exit direction of the light ray L₅ and the light ray L₄ exiting from the same strip-shaped prism 1022 may be the same (for example, parallel to the normal), the exit direction of the light ray L₇ and the light ray L₂ exiting from the same strip-shaped prism 1022 may be the same (for example, the angle between the emitting direction and the normal line is 20°), and the exit directions of different strip-shaped prisms 1022 match the VR optical paths.

Specifically, the design of each of the strip-shaped prisms 1022 may be completed according to the following contents. It will be illustrated by taking that two light rays exiting from the light guide plate 101 that have symmetrical angles θ₁ and θ₁′ with the normal line are respectively incident on two sides of the strip-shaped prism 1022 and then exit in a same set light exit direction as an example.

The propagation paths through the prism film 102 of the two light rays exiting from the light guide plate 101 that have symmetrical angles θ₁ and θ₁′ with the normal line are shown in FIG. 5 and FIG. 6 respectively.

In FIG. 5, n₁ represents refractive index of the stripe prism 1022, n₂ represents refractive index of the substrate 1021, n represents refractive index of an environmental medium, which is generally an air medium, and n=1 at this time. The first base angle α₁ and the light exit direction of the strip-shaped prism 1022 are on the same side of the normal line, the second base angle α₂ and the light exit direction of the strip-shaped prism 1022 are on different sides of the normal line, and α₃ represents the vertex angle of the strip-shaped prism 1022. θ₁ represents the angle between the light exiting from the left side of the light guide plate 101 and the normal line, θ₂ represents the complementary angle of θ₁, θ₃ represents the incident angle of the light exiting from the left side of the light guide plate 101 on side AB of the main cross-section of the strip-shaped prism 1022, θ₄ represents the refraction angle of the light exiting from the left side of the light guide plate 101 on side AB of the main cross-section of the strip-shaped prism 1022, θ₅ represents the incident angle of the light exiting from the left side of the light guide plate 101 on side BC of the main cross-section of the strip-shaped prism 1022, θ₆ represents the total reflection angle of the light exiting from the left side of the light guide plate 101 on side BC of the main cross-section of the strip-shaped prism 1022, θ₇ represents the incident angle of the light exiting from the left side of the light guide plate 101 on side AC of the main cross-section of the strip-shaped prism 1022, and θ represents the exit angle of the light exiting from the left side of the light guide plate 101 from the substrate 1021. From the law of refraction, the law of total reflection and the geometric angle relationships, the following relationship may be obtained:

$$\{ \begin{matrix}{θ}_{1} + {θ}_{2} = \frac{π}{2} \\ {θ}_{3} + \frac{π}{2} = π - {θ}_{2} - {α}_{2} \\ {α}_{1} + {α}_{2} + {α}_{3} = π \\ {θ}_{4} + {θ}_{5} = {α}_{3} \\ sin {θ}_{3} = {n}_{1} * sin {θ}_{4} \\ {θ}_{5} = {θ}_{6} \\ \frac{π}{2} - {θ}_{6} = π - {α}_{1} - ( \frac{π}{2} + {θ}_{7} ) \\ {n}_{1} * sin {θ}_{7} = sin θ\end{matrix}$$

In addition, during the propagation process of light shown in FIG. 5, if the light is totally reflected on side BC, the incident angle θ₅ should be greater than the critical total reflection angle, and if the light is refracted on side AC, the incident angle θ7 should be less than the critical total reflection angle. The specific conditions that need to be met are as follows:

$$\{ \begin{matrix}{θ}_{5} > arcsin \frac{1}{{n}_{1}} \\ {θ}_{7} < arcsin \frac{1}{{n}_{1}}\end{matrix}$$

Based on the above equations, the relationship between the exit angle θ of the light exiting from the left side of the light guide plate 101 after passing through the prism film 201 (that is, the incident light on the left side of the prism film 201) and θ₁, n₁, n₂, α₁ and α₂ are as follows:

$$\{ \begin{matrix}θ = arcsin \{ {n}_{1} * sin [ π - 2 {α}_{1} - {α}_{2} - arcsin \frac{sin ( {θ}_{1} - {α}_{2} )}{{n}_{1}} ] \} \\ {θ}_{5} = π - {α}_{1} - {α}_{2} - arcsin \frac{sin ( {θ}_{1} - {α}_{2} )}{{n}_{1}} > arcsin \frac{1}{{n}_{1}} \\ {θ}_{7} = {θ}_{5} - {α}_{1} = π - 2 {α}_{1} - {α}_{2} - arcsin \frac{sin ( {θ}_{1} - {α}_{2} )}{{n}_{1}} < arcsin \frac{1}{{n}_{1}}\end{matrix}$$

Similarly, from the schematic diagram of the incident light path on the right shown in FIG. 6, according to the law of refraction, the law of total reflection and the geometric angle relationship, the following relationship may be obtained:

$$\{ \begin{matrix}{θ}_{1}^{′} + {θ}_{2}^{′} = \frac{π}{2} \\ {θ}_{3}^{′} + \frac{π}{2} = π - {θ}_{2}^{′} - {α}_{1} \\ {α}_{1} + {α}_{2} + {α}_{3} = π \\ {θ}_{4}^{′} + {θ}_{5}^{′} = {α}_{3} \\ sin {θ}_{3}^{′} = {n}_{1} * sin {θ}_{4}^{′} \\ {θ}_{5}^{′} = {θ}_{6}^{′} \\ \frac{π}{2} - {θ}_{6}^{′} = π - {α}_{2} - ( \frac{π}{2} - {θ}_{7}^{′} ) \\ {n}_{1} * sin {θ}_{7}^{′} = sin {θ}^{′} \\ {θ}_{5}^{′} > arcsin \frac{1}{{n}_{1}} \\ {θ}_{7}^{′} < arcsin \frac{1}{{n}_{1}}\end{matrix}$$

In FIG. 6, θ₁′ represents the angle between the light exiting from the left side of the light guide plate 101 and the normal line, θ₂′ represents the complementary angle of θ₁′, θ₃′ represents the incident angle of the light exiting from the left side of the light guide plate 101 on side BC of the main cross-section of the strip-shaped prism 1022, θ₄′ represents the refraction angle of the light exiting from the left side of the light guide plate 101 on side BC of the main cross-section of the strip-shaped prism 1022, θ₅′ represents the incident angle of the light exiting from the left side of the light guide plate 101 on side AB of the main cross-section of the strip-shaped prism 1022, θ₆′ represents the total reflection angle of the light exiting from the left side of the light guide plate 101 on side AB of the main cross-section of the strip-shaped prism 1022, θ₇′ represents the incident angle of the light exiting from the left side of the light guide plate 101 on side AC of the main cross-section of the strip-shaped prism 1022, and θ′ represents the exit angle of the light exiting from the left side of the light guide plate 101 from the substrate 1021.

Based on the above equations, the relationship between the exit angle θ′ of the light exiting from the right side of the light guide plate 101 (that is, the incident light on the right side of the prism film 201) after passing through the prism film 201 and θ₁′, n₁, n₂, α₁ and α₂ are as follows:

$$\{ \begin{matrix}{θ}^{′} = arcsin \{ {n}_{1} * sin [ {α}_{1} + 2 {α}_{2} - π + arcsin \frac{sin ( {θ}_{1}^{′} - {α}_{1} )}{{n}_{1}} ] \} \\ {θ}_{5}^{′} = π - {α}_{1} - {α}_{2} - arcsin \frac{sin ( {θ}_{1}^{′} - {α}_{1} )}{{n}_{1}} > arcsin \frac{1}{{n}_{1}} \\ {θ}_{7}^{′} = {α}_{2} - {θ}_{5}^{′} = {α}_{1} + 2 {α}_{2} - π + arcsin \frac{sin ( {θ}_{1}^{′} - {α}_{1} )}{{n}_{1}} < arcsin \frac{1}{{n}_{1}}\end{matrix}$$

Based on the above equations, if the incident light from the left side and incident light from the right side of the prism film 201 satisfy θ₁=θ₁′, the angle of the strip-shaped prism 1022 may be selected to make θ=θ′. If the simultaneous equations have a solution, the effect of light directivity may be achieved for bidirectional incident lights. In particular, for the processing of the strip-shaped prism 1022, there is generally a fixed cutting tool angle, that is, α₃ is a fixed value. At this time, α₁+α₂=180−α₃, which is also a fixed value, therefore the following equations may be obtained:

$$\{ \begin{matrix}f ( {α}_{1} , {α}_{2} ) = θ - {θ}^{′} \\ = arcsin \{ {n}_{1} * sin [ π - 2 {α}_{1} - {α}_{2} - arcsin \frac{sin ( {θ}_{1} - {α}_{2} )}{{n}_{1}} ] \} - arcsin \{ {n}_{1} * sin [ {α}_{1} + 2 {α}_{2} - π + arcsin \frac{sin ( {θ}_{1}^{′} - {α}_{1} )}{{n}_{1}} ] \} \\ g ( {α}_{1} , {α}_{2} ) = {α}_{1} + {α}_{2} - C\end{matrix}$$

Among them, C represents a constant value. Under the constraints of the formula g(α₁, α₂)=α₁+α₂−C, a value of C may be found to minimize the absolute value of f(α₁, α₂), that is, θ≈θ′.

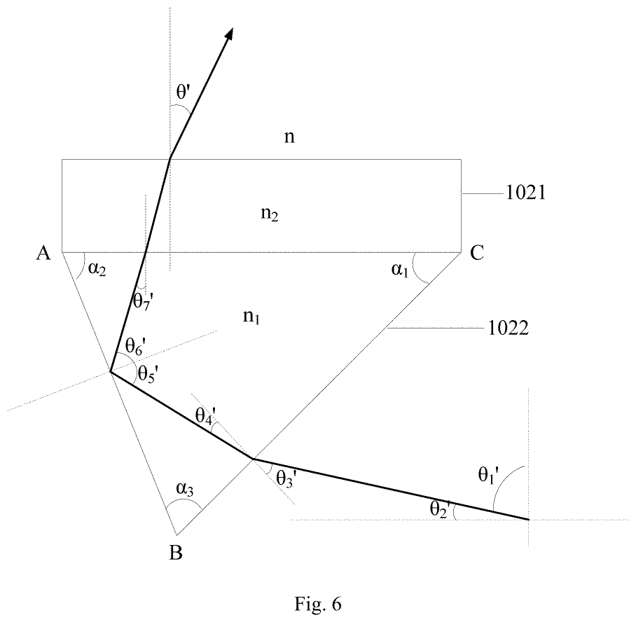

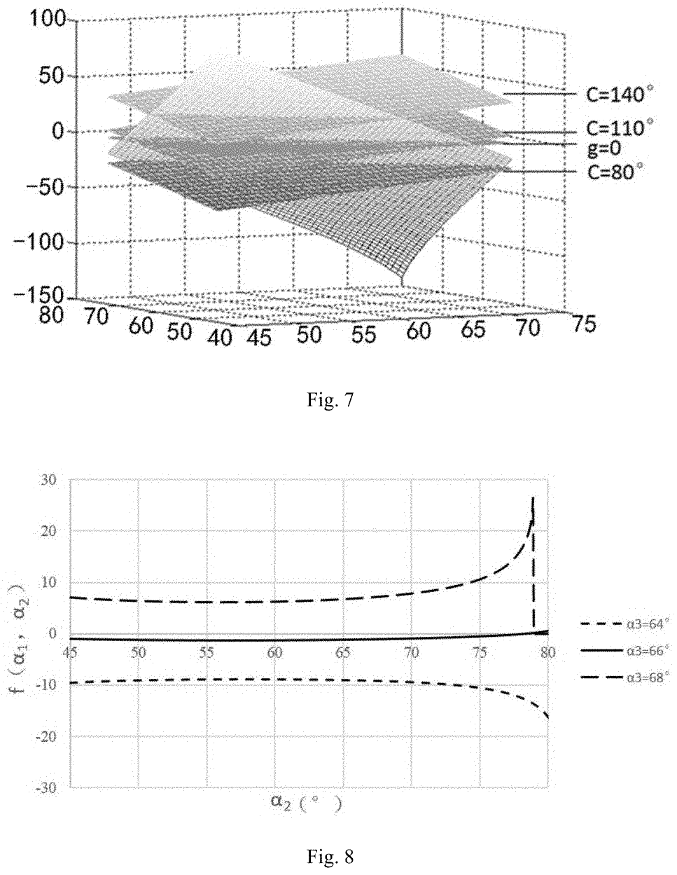

Taking an embodiment in which n₁=1.58 as an example, assuming that the light exit angle of the light guide plate θ₁=θ₁′=72°, the value of α₁ and α₂ may be found according to the formula f(α₁, α₂) and the formula g(α₁, α₂) by making the absolute value of f(α₁, α₂) the smallest. From a mathematical point of view, the formula f(α₁, α₂) represents a curved surface with α₁ and α₂ as independent variables, and the formula g(α₁, α₂) represents a plane with α₁ and α₂ as independent variables. The intersection of the plane represented by the formula g(α₁, α₂) and the plane represented by g(α₁, α₂)=0 is represented as α₁+α₂=C, α₃=180−C may be obtained at the same time, and α₁, α₂ and α₃ may compose a triangle. In summary, a value of C may be found, and at this time the f(α₁, α₂) corresponding to α₁ and α₂ on the intersection has the smallest absolute value. This intersection may be found by making C equal to the value of each angle, as shown in FIG. 7. After numerical search, it may be found that when C=114°, that is, α₃₌₆₆°, the absolute value of f(α₁, α₂) is the smallest, and the data of f(α₁, α₂) is shown in FIG. 8. Fixing α₃=66°, different target angles θ and θ′ may be obtained by selecting the corresponding α₂, and the corresponding angle data are shown in Table 1.

TABLE 1

| α₂ | θ | θ^{′} |
|---|---|---|
| 40° | −47.0° | −46.4° |
| 45° | −32.2° | −31.1° |
| 50° | −18.7° | −17.5° |
| 55° | −5.8° | −4.4° |
| 60° | 7.0° | 8.4° |
| 65° | 20.1° | 21.3° |
| 70° | 34.0° | 35.0° |
| 75° | 49.8° | 50.3° |
| 80° | 72.2° | 71.7° |

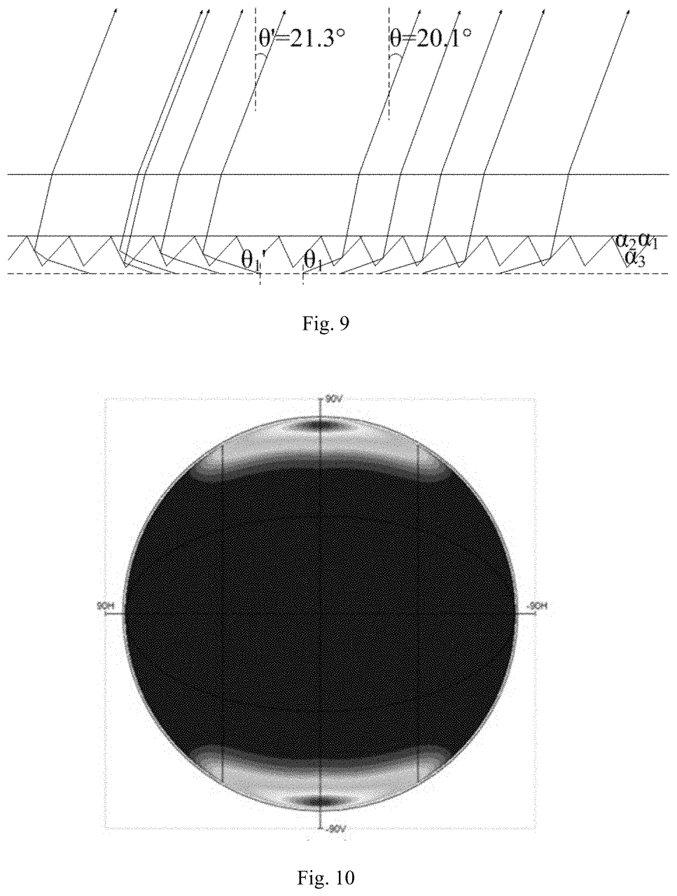

Specifically, n₁=1.58, assuming that the light exit angle of the light guide plate θ₁=θ₁′=72°, taking a target angle (that is, setting the angle between the exit direction and the normal line) 20° as an example, selecting α₁=49°, α₂=65° and α₃=66°, a Lighttools model with the corresponding angle parameters may be established, and the corresponding light path simulated by the Lighttools model is shown in FIG. 9. It may be seen that the incident light from the left side and the incident light from the right side (that is, the lights having symmetrical angles of 72° with the normal line) has approximately the same exit angle after passing through the prism film 102, which is about 20°.

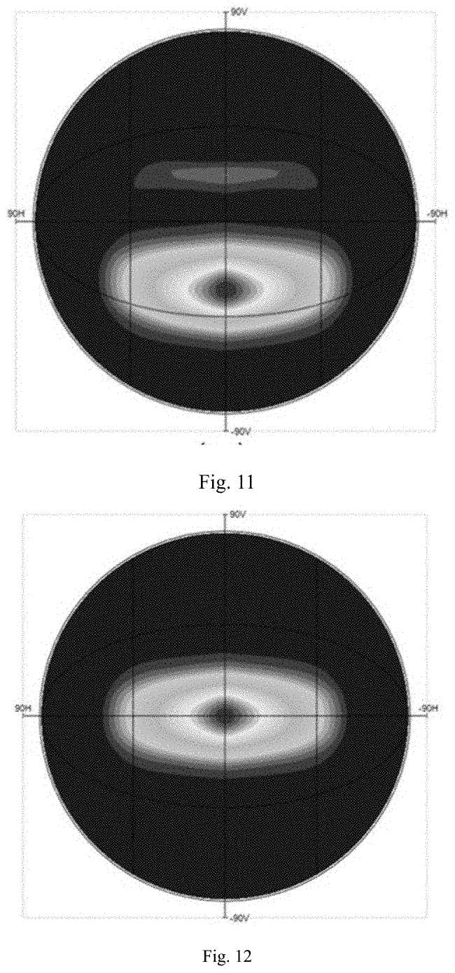

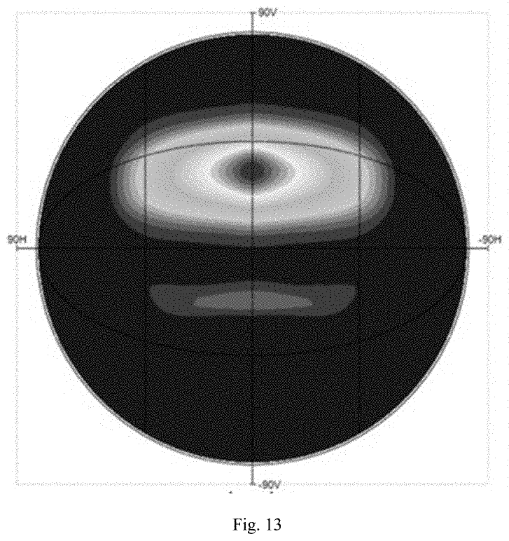

The above calculations are based on the central ray. Generally, the lights exiting from the light guide plate 101 are non-parallel lights and have a certain half-width. In order to illustrate the propagation paths of the non-central light rays through the prism film 102, corresponding optical simulations were performed in Lighttools using the above calculation data results. First, the light pattern of angular brightness distribution of the light guide plate 101 was imported into Lighttools. As shown in FIG. 10, it may be seen that the light pattern has two symmetrical light exit directions. Considering the propagation directions of the lights emitted by the light guide plate 101 through three positions on the prism film 102, the angles of the strip-shaped prisms in these three positions are (α₃=66°, α₁=49°) α₂=65°, (α₃=66°, α₁=57°)α₂=57° and (α₃=66°, α₁=65°)α₂=49°. The light patterns of angular brightness distribution of the light exiting from the light guide plate 101 after passing through these three positions are respectively shown in FIG. 11 to FIG. 13. It may be seen that most of the non-central two light rays exiting from the light guide plate 101 are distributed around the central light at the target angle after passing through the prism film 102. Such light distribution is suitable for the use of lights by VR.

From the above description, the display module shown in FIG. 1A may make the light exiting from the light guide plate have symmetrical angles with the normal line, and has a variety of set light exit directions, which achieves light directivity and improves light energy utilization. In addition, the set exit directions may be matched with the optical paths of a VR system, which is suitable for the VR system. Based on the principle similar to that of the display module shown in FIG. 1A, the display module shown in FIG. 2A may also achieve light directivity, improve light energy utilization, and the set exit directions may match the optical paths of a VR system, which is suitable for the VR system.

Based on the same inventive concept, an embodiment of the present disclosure also provides a display device, including the above-mentioned backlight module, and a display module located on the light exit side of the backlight module. The display device may be Virtual Reality (VR) display equipment, Notebooks (NB) computer, displays and other display products or components of any size. Since the principle based on which the problems are solved of the display device is similar to the principle based on which the problems are solved of the above-mentioned backlight module, the implementations of the display device may refer to the embodiments of the above-mentioned backlight module, and the repetition will not be described.

The backlight module and the display device provided by the embodiments of the present disclosure include: a light guide plate, and a prism film located on a side of a light exit surface of the light guide plate, where the prism film includes a substrate, and a plurality of strip-shaped prisms disposed on a side of the substrate facing the light guide plate, the plurality of strip-shaped prisms extending in a first direction and arranged in a second direction; and the base angles of each of the strip-shaped satisfy following conditions that two light rays exiting from the light guide plate that have symmetrical angles with a normal line of the light exit surface of the light guide plate are respectively incident on two sides of the strip-shaped prism, and then exit in a same set light exit direction; the prism film has at least two light exit directions. The base angles of each of the strip-shaped prisms of the backlight module satisfy following conditions that two light rays exiting from the light guide plate that have symmetrical angles with a normal line of the light exit surface of the light guide plate are respectively incident on two sides of the strip-shaped prism, and then exit in a same set light exit direction; the prism film has at least two light exit directions. Specifically, the two light rays exiting from the light guide plate that have symmetrical angles with the normal line are respectively the light rays emitted by the side-type backlight exiting from the light guide plate and the light rays reflected by the reflective sheet, or, are respectively the light rays emitted by the double light bars exiting from the light guide plate. Therefore, the backlight module provided by the present disclosure achieves light exit in given direction and improve light energy utilization.

Obviously, those skilled in the art may make various changes and modifications to the application without departing from the spirit and scope of the application. In this way, if these modifications and variations of this application fall within the scope of the claims of this application and their equivalent technologies, then this application is also intended to include these modifications and variations.

1. A backlight module, comprising a light guide plate, and a prism film located on a side of a light exit surface of the light guide plate; wherein,
the prism film comprises:
a substrate, and
a plurality of strip-shaped prisms disposed on a side of the substrate facing the light guide plate, wherein the plurality of strip-shaped prisms extend in a first direction and are arranged in a second direction;
each of the strip-shaped prisms comprises a first base angle and a second base angle, and the first base angle and the second base angle satisfy following conditions that after two light rays exiting from the light guide plate that have symmetrical angles with a normal line of the light exit surface of the light guide plate are respectively incident on two sides of the each of the strip-shaped prisms corresponding to the first base angle and the second base angle, the two light rays exit in a same set light exit direction; the prism film has at least two light exit directions,
wherein, the prism film comprises at least a first light exit region and a second light exit region that are symmetrically distributed around a central axis extending in the first direction, light exit directions of each of the strip shaped prisms in the first light exit region are the same, and light exit directions of each of the strip shaped prisms in the second light exit region are the same;
wherein, a light exit direction of the first light exit region points to the normal line with a first angle therebetween, and a light exit direction of the second light exit region deviates from the normal line with a second angle therebetween, the first angle being the same as the second angle;
wherein, in the first light exit region and the second light exit region, the first base angle of each of the strip-shaped prisms is smaller than the second base angle of each of the strip-shaped prisms, and the first base angle is located at a downstream position as compared with the second base angle along a light exit direction of the strip-shaped prism.

2-4. (canceled)

5. The backlight module according to claim 1, wherein the greater a difference between the first base angle and the second base angle is, the greater an angle at which the light exit direction of the strip-shaped prism deviates from the normal line is.

6. The backlight module according to claim 1, wherein the light exit direction of the first light exit region and the light exit direction of the second light exit region both point to or deviate from the central axis.

7. The backlight module according to claim 1, wherein the prism film further comprises a third light exit region located between the first light exit region and the second light exit region;
a light exit direction of the third light exit region is parallel to the normal line.

8. The backlight module according to claim 7, wherein the first base angle of each of the strip-shaped prisms and the second base angle of each of the strip-shaped prisms in the third light exit region are the same.

9. The backlight module according to claim 8, wherein each of the strip-shaped prisms is a strip-shaped triangular prism, and in a main cross-section of each of the strip-shaped prisms, vertex angles on a side away from the substrate are the same.

10. The backlight module according to claim 9, wherein in a main cross-section of each of the strip-shaped prisms, bases on a side close to the substrate are equal.

11. The backlight module according to claim 9, wherein heights of a main cross-section of each of the strip-shaped prisms are equal.

12. The backlight module according to claim 1, further comprising a first light source located on a first side of the light guide plate, a second light source or a reflective sheet located on a second side of the light guide plate, and a back plate located on an opposite side of the light exit surface of the light guide plate; wherein, the first side is arranged opposite to the second side.

13-16. (canceled)

17. A display device, comprising a backlight module, and a display module located on a light exit side of the backlight module,
wherein, the backlight module comprises a light guide plate, and a prism film located on a side of a light exit surface of the light guide plate;
wherein, the prism film comprises a substrate, and a plurality of strip-shaped prisms disposed on a side of the substrate facing the light guide plate, wherein the plurality of strip-shaped prisms extend in a first direction and are arranged in a second direction;
wherein, each of the strip-shaped prisms comprises a first base angle and a second base angle, and the first base angle and the second base angle satisfy following conditions that after two light rays exiting from the light guide plate that have symmetrical angles with a normal line of the light exit surface of the light guide plate are respectively incident on two sides of the each of the strip-shaped prisms corresponding to the first base angle and the second base angle, the two light rays exit in a same set light exit direction; the prism film has at least two light exit directions,
wherein, the prism film comprises at least a first light exit region and a second light exit region that are symmetrically distributed around a central axis extending in the first direction, light exit directions of each of the strip shaped prisms in the first light exit region are the same, and light exit directions of each of the strip shaped prisms in the second light exit region are the same;
wherein, a light exit direction of the first light exit region points to the normal line with a first angle therebetween, and a light exit direction of the second light exit region deviates from the normal line with a second angle therebetween, the first angle being the same as the second angle;
wherein, in the first light exit region and the second light exit region, the first base angle of each of the strip-shaped prisms is smaller than the second base angle of each of the strip-shaped prisms, and the first base angle is located at a downstream position as compared with the second base angle along a light exit direction of the strip-shaped prism.

18. The display device according to claim 17, wherein the display device is a virtual reality display device.

19. (canceled)

20. (canceled)
